(19) United States
(12) Patent Application Publication
(10) Pub. No.: US 2023/0136498 A1
(43) Pub. Date: May 4, 2023

(54) EXPANDABLE CLOSURE SYSTEM

(71) Applicant: PREFORMED LINE PRODUCTS CO., Mayfield Village, OH (US)

(72) Inventors: Benjamin Franklin CIESIELCZYK, Madison, OH (US); Cameron Joseph CLINES, Chagrin Falls, OH (US); Jacob Jeffrey PALMER, Chesterland, OH (US)

(21) Appl. No.: 17/977,699

(22) Filed: Oct. 31, 2022

Related U.S. Application Data
(60) Provisional application No. 63/274,259, filed on Nov. 1, 2021.

(51) Int. Cl. G03B 11/04; G02B 23/16

(52) U.S. Cl. CPC G03B 11/04; G02B 23/16; B65D 21/0202

(57) ABSTRACT

A closure enclosing and protecting at least one line splice holder. The closure includes a first housing portion enclosing at least a portion of a hollow interior of the closure, the at least one line splice holder being located within the hollow interior. The first housing portion has a portal through which plural lines extend into the hollow interior. The closure includes a second housing portion actuatable with respect to the first housing portion to provide an additional portion of the hollow interior. The additional portion of the hollow interior is a volume to receive additional of the at least one line splice holder. The closure includes a coupling for connecting the second housing portion to the first housing portion.

### RELATED APPLICATION(S)

This application claims priority to provisional application U.S. 63/274,259, filed on Nov. 1, 2021, entitled “EXPANDABLE CLOSURE SYSTEM” which is incorporated by reference herein.

### FIELD

The present disclosure relates to closures that enclose and protect line splice holders and the spliced lines thereon.

### BACKGROUND

Elongate lines, such communication wires, cables, optical fibers or the like, extend to a use location (e.g., a building, dwelling of the like). At the use location, the elongate lines are connected for termination, splicing or the like.

Typically, at the use location, such termination, splicing or the like, is performed upon at least one splice holder or similar structure. Also, typically at the use location, a closure is provided for the at least one splice holder to be located therein. The closure encloses and protects the at least one line splice holder and the terminations, splicing or the like thereon.

As can be appreciated, the closure has an interior volume. The at least one line splice holder and the terminations, splicing or the like thereon must fit within the closure. If there is a later desire to have a greater number of splice holders and associated terminations, splicing or the like thereon (e.g., such may occur during a system upgrade), a lack of further available interior space within the closure may occur.

To address the topic of needed further interior space, a new, larger closure is provided as a complete replacement. It is to be noted that providing a new, larger closure may be costly and may be a time-consuming process. It is to be noted that providing a new, larger closure may also involve risks of damage, disconnection and the like to lines and/or contents (e.g., splice holder(s)) within the original closure. Such damage, disconnection and the like may also be associated with disruption of provided service (e.g., communications).

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

In accordance with one or more aspects, the present disclosure provides a closure enclosing and protecting at least one line splice holder. The closure includes a first housing portion enclosing at least a portion of a hollow interior of the closure, the at least one line splice holder being located within the hollow interior. The first housing portion has a portal through which plural lines extend into the hollow interior. The closure includes a second housing portion actuatable with respect to the first housing portion to provide an additional portion of the hollow interior. The additional portion of the hollow interior is a volume to receive additional of the at least one line splice holder. The closure includes a coupling for connecting the second housing portion to the first housing portion.

In accordance with one or more aspects, the present disclosure provides a closure enclosing and protecting one or more line splice holders. The closure includes a first housing portion defining a first portion of an interior of the closure. The closure includes a second housing portion defining a second portion of the interior of the closure. The closure includes a coupling for connecting the second housing portion to the first housing portion. The first housing portion and the second housing portion are movable relative to one another between a first position and a second position. When the first housing portion and the second housing portion are in the first position relative to one another, the interior of the closure has a first volume. When the first housing portion and the second housing portion are in the second position relative to one another, the interior of the closure has a second volume greater than the first volume. The first volume accommodates a first number of the one or more line splice holders. The second volume accommodates a second number, greater than the first number, of the one or more line splice holders.

The following description and annexed drawings set forth certain illustrative aspects and implementations. These are indicative of but a few of the various ways in which one or more aspects may be employed. Other aspects, advantages, and/or novel features of the disclosure will become apparent from the following detailed description when considered in conjunction with the annexed drawings.

### DESCRIPTION OF THE DRAWINGS

FIG. 1 is an exploded perspective view of an example closure, including an optional extension portion, accordance with at least one aspect of the present disclosure.

FIG. 2 is perspective view of the example closure of FIG. 1 showing a shortened, but closed, position that does not include the optional extension portion.

FIG. 3 is a view of the example closure of FIG. 1 showing an elongated, but closed, position that includes the optional extension portion.

FIG. 4 is a photograph of example lines, and contents (e.g., splice holder(s)), that may be within a closure, such as the example closures presented within the present disclosure.

FIG. 5 is an exploded perspective view of an example closure accordance with at least one aspect of the present disclosure.

FIG. 6 is perspective view of the example closure of FIG. 5 showing a closed condition in which the closure is in a telescoped inward position.

FIG. 7 is perspective view of the example closure of FIG. 5 showing an open condition in which the closure is in a telescoped outward position.

FIG. 8 is a perspective view of only a second housing portion of the example closure of FIG. 5 and showing an interior of the second housing portion with two threaded portions therein.

FIG. 9 is an exploded perspective view of an example closure accordance with at least one aspect of the present disclosure.

FIG. 10 is perspective view of the example closure of FIG. 9 showing the closure in a telescoped inward position.

FIG. 11 is perspective view of the example closure of FIG. 9 showing the closure in a telescoped outward position.

### DETAILED DESCRIPTION

The claimed subject matter is now described with reference to the drawings, wherein like reference numerals are used to refer to like elements throughout. In the following description, for purposes of explanation, numerous specific details are set forth in order to provide an understanding of the claimed subject matter. It is evident, however, that the claimed subject matter may be practiced without these specific details. In other instances, structures and devices are illustrated in block diagram form in order to facilitate describing the claimed subject matter. Relative size, orientation, etc. of parts, components, etc. may differ from that which is illustrated while not falling outside of the scope of the claimed subject matter.

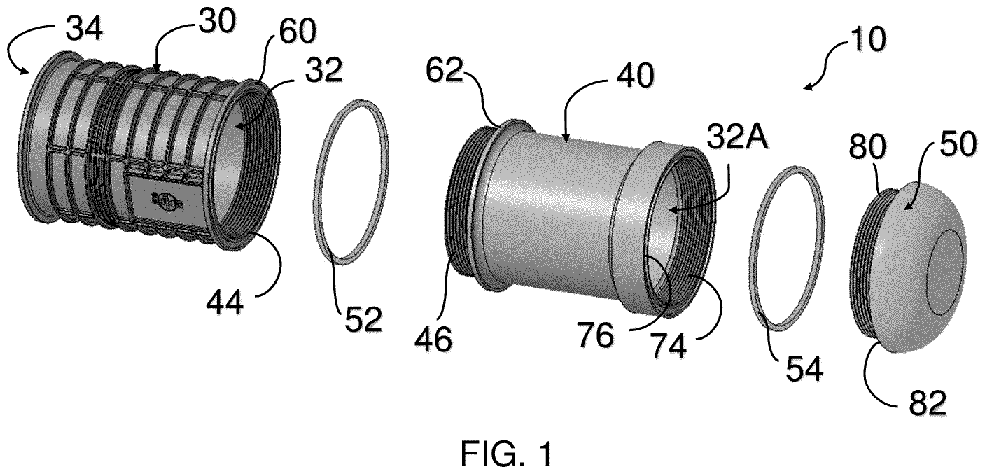

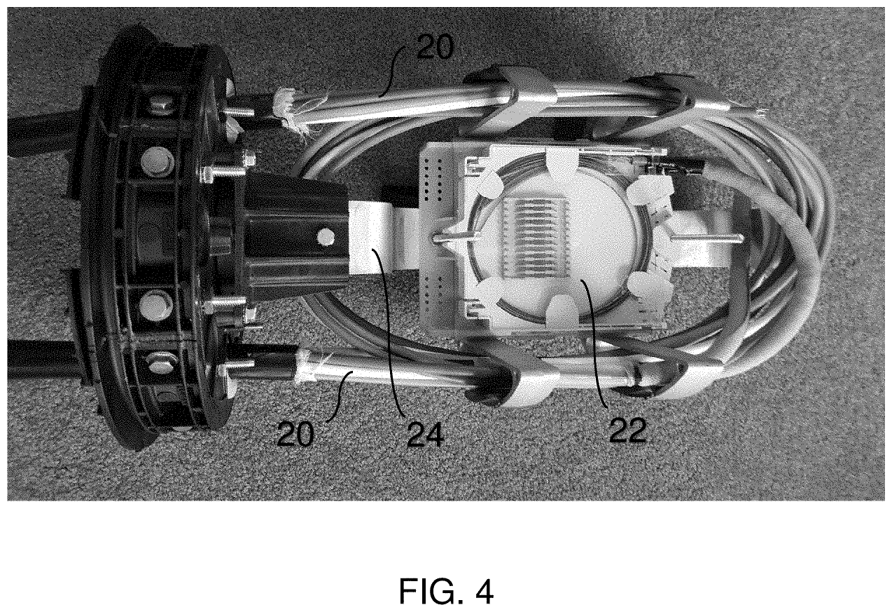

An example closure 10 in accordance with at least one aspect of the present disclosure is shown within FIGS. 1-3. The closure 10 is for enclosing and protecting at least one line splice holder. FIG. 4 shows an example of line(s) 20 that may enter a closure, such as the closure 10 (FIGS. 1-3), an example line splice holder 22, that may be within a closure, such as the closure 10, and example other structure(s) 24 that may be within/associated with a closure, such as the closure 10. It is to be appreciated that FIG. 4 is not provided to indicate any limitation upon the present disclosure. FIG. 4, is only to provide an example of a use environment for a closure, such as the closure 10. It is to be noted that the examples shown within FIG. 4 may also be associated with other closures presented within this disclosure. Such provides an example of a use environment for such other closure(s). It is to be noted that the use environment (e.g., line(s), line splice holder(s), and other structure(s)) may be varied, different, be of different number, etc.

Returning focus to FIGS. 1-3, the example closure 10 includes a first housing portion 30 enclosing at least a portion of a hollow interior 32 of the closure 10. Within the shown example, the first housing portion 30 has a cylindrical shape. Within an example, at least one line splice holder, possibly the example line splice holder 22 (FIG. 4), is to be located within the hollow interior 32. The first housing portion 30 has a portal 34. Within the shown example, the portal 34 is an open end (e.g., an opening) at an axial end of the cylindrical shape. Within an example, plural lines, such as the lines 20 shown within FIG. 4, extend into the hollow interior 32 through the portal 34. It is to be appreciated that the portal 34 may receive structure (e.g., a cap, a plug or similar, such as shown as part of the other structure(s) 24 shown within FIG. 4).

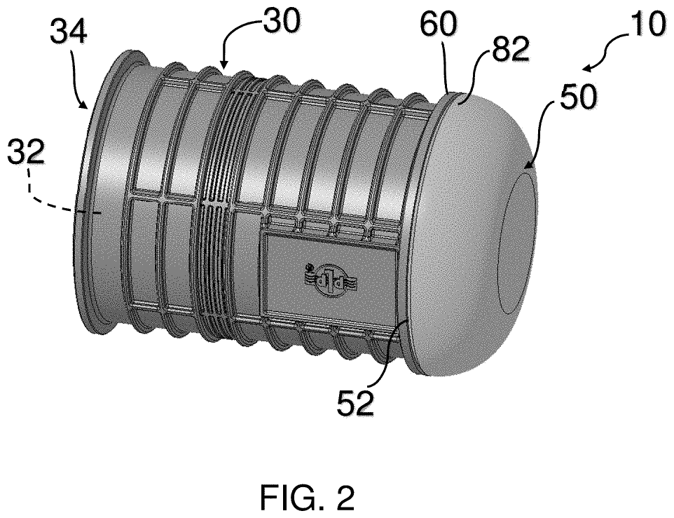

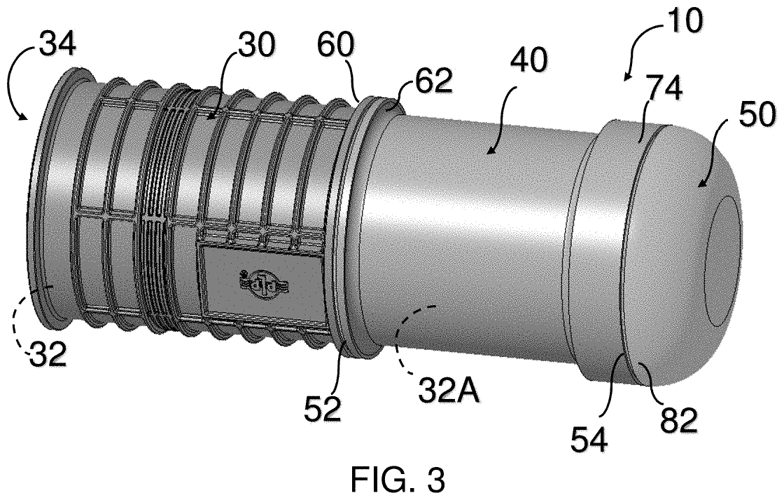

The example closure 10 includes a second housing portion 40. It is to be appreciated that the second housing portion 40 is actuatable with respect to the first housing portion 30 to provide an additional portion 32A of the hollow interior 32. Within an example, the additional portion 32A of the hollow interior 32 is a volume to receive one or more additional line splice holder(s). It is to be appreciated that use of the second housing portion 40 is optional (e.g., compare FIG. 2 and FIG. 3).

It is to be appreciated that the aspect of the second housing portion 40 being actuatable with respect to the first housing portion 30 to provide an additional portion 32A of the hollow interior 32 is to be broadly interpreted. In general, the second housing portion 40 is involved in some activity (e.g., motion, attachment, or the like) relative to the first housing portion 30 such that the result is the provision of the additional portion 32A of the hollow interior 32. The present example closure 10 (FIGS. 1-3) is provided as just an example of the aspect of a second housing portion being actuatable with respect to a first housing portion to provide an additional portion of a hollow interior. Other example closures discussed later provide other examples of the aspect of a second housing portion being actuatable with respect to a first housing portion to provide an additional portion of a hollow interior. However, it is to be appreciated that such discussed examples need not be limitations upon the present disclosure and that other examples are contemplated and within the scope of the present disclosure.

The example closure 10 includes a coupling for connecting the second housing portion 40 to the first housing portion 30. It is to be appreciated that the coupling for connecting the second housing portion 40 to the first housing portion 30 is to be broadly interpreted. The coupling may have a variety of constructions and configurations. Such variety is within the scope of the present disclosure. Within the shown example of FIGS. 1-3, the example coupling for connecting the second housing portion 40 to the first housing portion 30 are matting threaded portions 44, 46 respectively on the first housing portion 30 and the second housing portion 40. Within the shown example, the threaded portion 44 is a female threaded portion and the threaded portion 46 is a male threaded portion, but such may be reversed. The second housing portion 40 is connected to the first housing portion 30 via inserting the threaded portion 46 into the threaded portion 44 and the second housing portion 40 is rotated relative to the first housing portion 30 until sufficient tightening occurs. See FIG. 3, which shows the second housing portion 40 sufficiently tightening onto the first housing portion 30. Again, it is to be appreciated that the use of threaded portions provides just an example and that other examples, which include other constructions and configurations (e.g., other/additional portions) for connection and holding of the housing portions, are within the scope of the present disclosure. For example, collars, clamps, twist-locks, interfitting portions, etc. may be included within other examples that are within the scope of the present disclosure.

It is to be appreciated that the above discussed broad example is to provide a broad appreciation of the scope of the disclosure. It is to be appreciated that additional/different components/structures/features may be provided. As an example of such, the example of FIGS. 1-3 is now further described to regarding additional components/structures/features. FIG. 1 shows a cap 50 and two O-ring seals 52, 54 as additional components.

The first housing portion 30 has an annular shoulder 60 encircling an entrance to the threaded portion 44. The second housing portion 40 has an annular shoulder 62 encircling a distal end of the threaded portion 46. The O-ring seal 52 is for seating against the annular shoulder 60 of the first housing portion 30. When the second housing portion 40 is connected to the first housing portion 30, via inserting/tightening the threaded portion 46 into the threaded portion 44, the O-ring seal 52 is also seated against the annular shoulder 62 of the second housing portion 40. As such the O-ring seal 52 seals between the first and second housing portions 30, 40. See FIG. 3. Of course, other examples, such as examples that do not include threaded portions may utilize other constructions and configurations.

At a second end, distal from the threaded portion 46 and shoulder 62, the second housing portion 40 has a female threaded portion 74 and an annular shoulder 76 encircling an entrance to the threaded portion 74. The O-ring seal 54 is for seating against the annular shoulder 76 of the second housing portion 40. It is to be appreciated that the female threaded portion 74 of the second housing portion 40 has the same size and configuration as the female threaded portion 44 of the first housing portion 30. Here also, such is just an example and that other examples, that may utilize other constructions and configurations (e.g., that do not include threaded portions for connection), are within the scope of the present disclosure.

The cap 50 has a male threaded portion 80 and an annular shoulder 82 encircling a distal end of the threaded portion 80. It is to be appreciated that the male threaded portion 80 of the cap 50 has the same size and configuration as the male threaded portion 46 of the second housing portion 40. The male threaded portion 80 of the cap 50 may threadingly engage/mate into the female threaded portion 74 of the second housing portion 40. As such, the cap 50 connects to the second housing portion 40, via inserting/tightening the male threaded portion 80 into the female threaded portion 74. During such insertion/tightening, the second O-ring seal 54 is also seated against the annular shoulder 82 of the cap 50. As such the second O-ring seal 54 seals between the second housing portion 40 and the cap 50. See FIG. 3. Such connection of the first housing portion 30, the second housing portion 40 and the cap 50 provides an enclosed space that has the hollow interior 32 with the additional portion 32A. See FIGS. 1 and 3.

It is to be appreciated that the example closure 10 as shown in FIG. 3 may be a result of a desire to have the additional portion 32A of the hollow interior 32. Such may be part of additions of splice holder(s) 22, additions of example other structure(s) 24, or the like.

It is to be appreciated that the example closure 10, with inclusion of the second housing portion 40 and both O-ring seals 52, 54, may be provided as a kit. The use of the second housing portion 40 and both O-ring seals 52, 54 may be an option. Also, the provision of the second housing portion 40, with use of both seals 52, 54, may be an optional add-on. It is to be appreciated that for other examples, the kit may, of course, contain other, different items. Such different items may be dependent upon the variation, such as variations in the connections. Thus, other example kits may include other connection items such as collars, clamps, couplers, clips, closures, interfitting parts, etc. to hold the housing portions. So, the specifics as to the connections (e.g., use of threaded portions of the shown example) need not be a limitation upon the present disclosure.

Focusing now to FIG. 2, recall that the male threaded portion 80 of the cap 50 has the same size and configuration as the male threaded portion 46 of the second housing portion 40. As such, the male threaded portion 80 of the cap 50 may threadingly engage into the threaded portion 44 of the first housing portion 30. The first O-ring seal 52 is also seated against/between the annular shoulder 60 of the first housing portion 30 and the annular shoulder 82 of the cap 50. The second housing portion 40 and the second O-ring seal 54 are not utilized within the arrangement as shown within FIG. 2.

It is to be appreciated that the example closure 10 as shown in the arrangement of FIG. 2 may be a result of a desire not to have the additional portion 32A of the hollow interior 32 (i.e., only the hollow interior 32 as provided by the first housing portion 30). Such may be associated within use of just one or other lower number of splice holder(s) 22, other structure(s) 24, or the like. As such, closure 10 is an example of a closure wherein the second housing portion 40 is removed from the first housing portion 30 to provide a relatively smaller hollow interior 32 of the closure and the second housing portion is added to the first housing portion for a relatively larger hollow interior (i.e., 32 and 32A) of the closure. Again, the connection of the shown example includes a threaded connection, but such is only an example that that other variations are within the scope of the present disclosure. As such, the connection that is intended to only provide the relatively smaller hollow interior may be varied based upon the variation of the connection that is for adding the additional portion of the interior via the second housing portion.

It is to be appreciated that, if desired, still further housing portions (e.g., third, etc.) could be utilized for providing still further additional portions to the hollow interior. Such may be accomplished via providing such third, etc. housing portions to be duplicates of the second housing portion 40. Also, as needed, additional (e.g., third, etc.) O-rings, that are duplicates of the second O-ring, may be provided as needed. Each successive housing portion (e.g., third) would be threadingly engaged, with an O-ring interposed for sealing, to the previous housing portion (e.g., second) in a sequence. The cap 50 would be threadingly engaged, with an O-ring interposed, to the last housing portion of the sequence. Here also, variation (i.e., variation from use of threaded connections), are contemplated and within the scope of the present disclosure.

It is to be appreciated that all of such additions of housing portions (e.g., the second housing portion 40 added to the first housing portion 30, a possible third housing portion added to the second housing portion 40, etc.) may be accomplished to provide successive additional portion(s) (e.g., 32A) to the hollow interior 32. It is to be appreciated that such additions may be accomplished with no or only minimal disturbance to the line(s) 20, line splice holder 22, other structure(s) 24 that may already be within/associated with the pre-existing, and smaller hollow interior 32 of the closure 10.

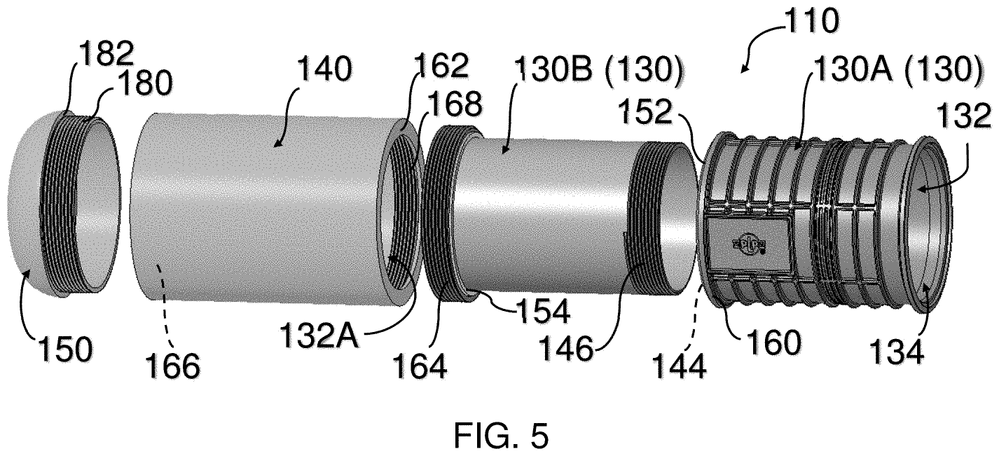

FIGS. 5-7 show an example closure 110 in accordance with at least one aspect of the present disclosure. The example closure 110 includes an ability to telescope to change volume size of a hollow interior 132 of the closure 110.

The example closure 110 includes a first housing portion 130A/130B (130) enclosing at least a portion of the hollow interior 132 of the closure 110. Within the shown example, the first housing portion 130A/130B (130) has a general cylindrical shape. Within an example, at least one line splice holder, possibly the example line splice holder 22 (FIG. 4), is to be located within the hollow interior 132. The first housing portion 130A/130B (130) has a portal 134. Within the shown example, the portal 134 is an open end (e.g., an opening) at an axial end of the cylindrical shape. Within an example, plural lines, such as the lines 20 shown within FIG. 4, extend into the hollow interior 132 through the portal 134. It is to be appreciated that the portal 134 may receive structure (e.g., a cap, a plug or similar, such as shown as part of the other structure(s) 24 shown within FIG. 4.

It is to be noted that example first housing portion 130A/130B (130) is shown within FIG. 5 as two pieces (i.e., piece 130A and piece 130B). The two pieces 130A and 130B are made as separate items and that connected together for use. It is to be appreciated that first housing portion 130 may be made as a single piece. Of course, such modification is within the scope of the present disclosure. The making of two pieces 130A and 130B as separate items may allow at least some of the two pieces 130A and 130B to utilized within other examples (e.g., piece 130A may be utilized as the first housing portion 30 of the example shown in FIGS. 1-3).

In view of the first housing portion 130A/130B (130) being shown within FIG. 5 as two pieces (i.e., piece 130A and piece 130B), some structures upon the two pieces that are associated within the use of two pieces are explained. The first and second pieces 130A, 130B include a coupling for connecting the first and second pieces together. Within the shown example of FIG. 5, the coupling for connecting the first and second pieces 130A/130B are matting threaded portions 144 (hidden from view in FIG. 5, represented via dash hidden indicating lead line), 46 respectively on the first piece 130A and the second piece 130B. Once the threaded portions 144, 146 are tightened together, the first and second pieces 130A/130B the first and second pieces of the first housing portion 130A/130B (130) no longer move relative to each other. But again, the first housing portion 130A/130B (130) may instead be made as a single piece. A single piece first housing portion would obviate the need for the threaded portions 144, 146.

The example closure 110 includes a second housing portion 140. It is to be appreciated that the second housing portion 140 is actuatable with respect to the first housing portion 130A/130B (130) to provide an additional portion 132A of the hollow interior 132. Within an example, the additional portion 132A of the hollow interior 132 is a volume to receive one or more additional line splice holder(s).

It is to be appreciated that the aspect of the second housing portion 140 being actuatable with respect to the first housing portion 130 to provide an additional portion 132A of the hollow interior 132 is to be broadly interpreted. In general, the second housing portion 140 is involved in some activity (e.g., motion, attachment, or the like) relative to the first housing portion 130 such that the result is the provision of the additional portion 132A of the hollow interior 132. The present example closure 110 (FIGS. 5-7) is provided as just an example of the aspect of a second housing portion being actuatable with respect to a first housing portion to provide an additional portion of a hollow interior. Other example closures discussed herein provide other examples of the aspect of a second housing portion being actuatable with respect to a first housing portion to provide an additional portion of a hollow interior. However, it is to be appreciated that such discussed examples need not be limitations upon the present disclosure and that other examples are contemplated and within the scope of the present disclosure.

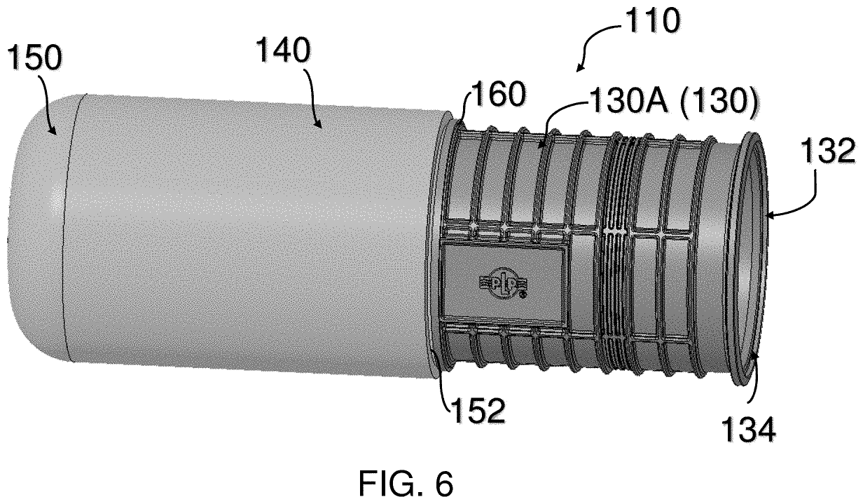

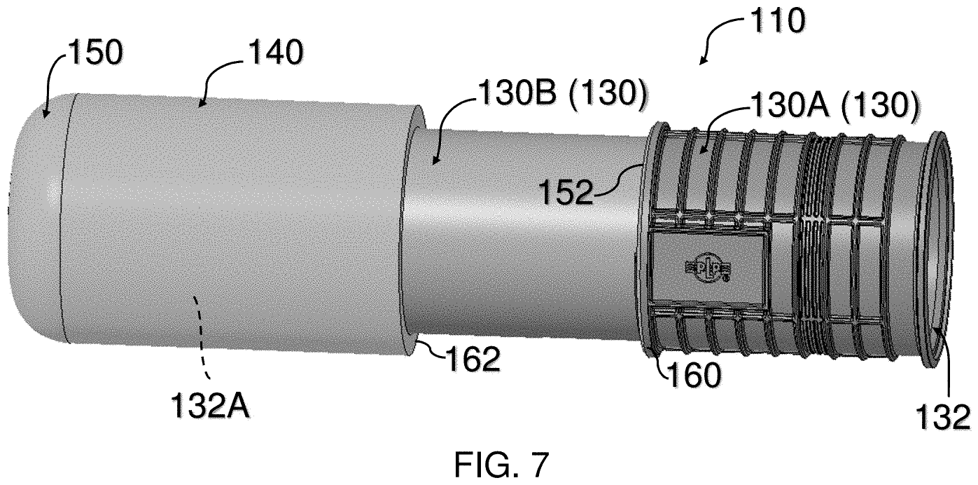

The example closure 110 includes a coupling for connecting the second housing portion 140 to the first housing portion 130, with the coupling connecting the second housing portion 140 to the first housing portion 130 in either of two positions. FIG. 6 shows the second housing portion 140 connected to the first housing portion 130 in a first, closed, telescoped-in position. FIG. 7 shows the second housing portion 140 connected to the first housing portion 130 in a second, open, telescoped-out position. The position of FIG. 7 is telescoped outward relative to the position of FIG. 6.

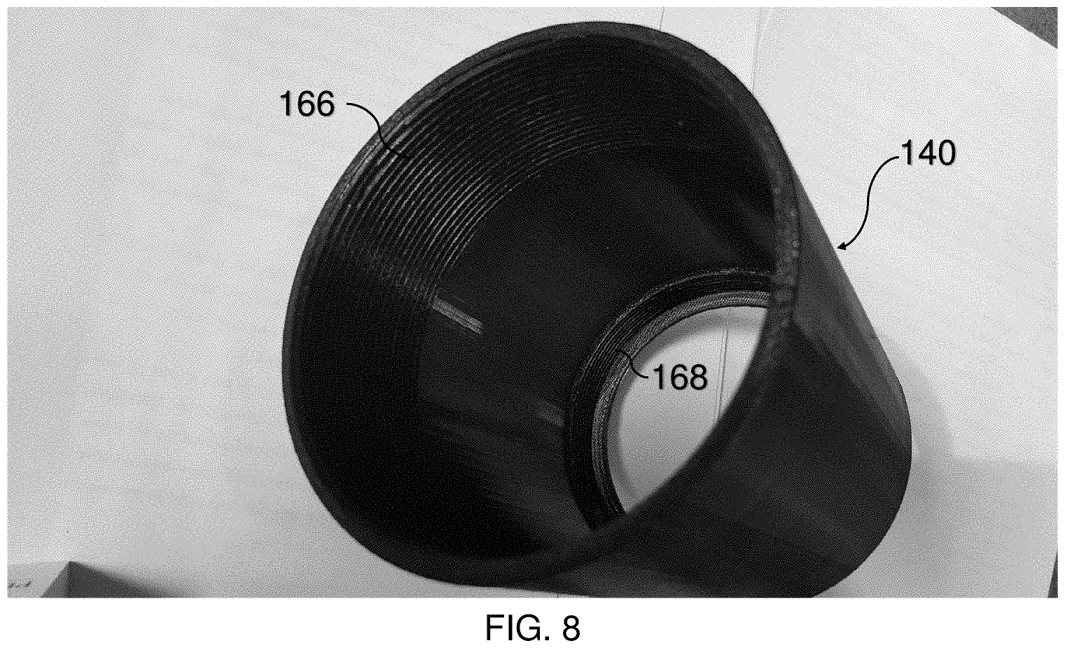

Within the shown example of FIGS. 5-7, the coupling for connecting the second housing portion 140 to the first housing portion 130 are matting threaded portions. Moreover, the matting threaded portions may mate in different matting pairings. The first housing portion 130, and specifically the second piece 1308 of the housing portion, has a male threaded portion 164. The second housing portion 140 has two, spaced-apart female threaded portions 166, 168 within a hollow interior of the second housing portion. See FIG. 8. A first female threaded portion 166 is located adjacent to one end of the second housing portion 140 and a second female threaded portion 168 is located adjacent to a second end of the second housing portion.

In the first position of the second housing portion 140 relative to the first housing portion 130 (see FIG. 6), the male threaded portion 164 of the first housing portion 130 is threadingly engaged with the first female threaded portion 166. In the second position of the second housing portion 140 relative to the first housing portion 130 (see FIG. 7), the male threaded portion 164 of the first housing portion 130 is threadingly engaged with the second female threaded portion 168. In order to move from the first position to the second position, the male threaded portion 164 is unscrewed from the first female threaded portion 166, then the second housing portion 140 is telescopingly slid outward relative to the first housing portion 130 and then the male threaded portion 164 is screwed into the second female threaded portion 168. Of course, the use of threaded connections is just an example. The present disclosure is not limited to threaded connections and that variations in constructions and configurations are contemplated and within the scope of the present disclosure. For example, clamps, couplers, twist-locks, interfitting portions, etc. to hold the housing portions may be included within other examples that are within the scope of the present disclosure.

It is to be appreciated that the above discussed broad example is to provide a broad appreciation of the scope of the disclosure. It is to be appreciated that additional/different components/structures/features may be provided. As an example of such, the example of FIGS. 5-7 is now further described to regarding additional components/structures/features. FIG. 5 shows a cap 150 and two O-ring seals 152, 154 as additional components.

The first piece 130A of the first housing portion 130 has an annular shoulder 160 encircling an entrance to the threaded portion 144. The second housing portion 140 has an annular shoulder 162 encircling the end adjacent to the threaded portion 168. The O-ring seal 152 is for seating against the annular shoulder 160 of the first housing portion 130. When the second housing portion 140 is in the first position relative to the first housing portion 130, via tightening the threaded portion 164 into the first threaded portion 166 of the second housing portion 140, the O-ring seal 152 is also seated against the annular shoulder 162 of the second housing portion 140. As such the O-ring seal 152 seals between the first and second housing portions 130, 410. See FIG. 6.

Adjacent to the threaded portion 164 of the first housing portion 130 (i.e., upon the first piece 130A), the O-ring seal 154 encircles the first housing portion 130. It is to be noted that the threaded portion 164 has a larger diameter than the remainder of the first piece 130A. See FIG. 5. As such, a base of the threaded portion 164 provides a shoulder-like structure against which the O-ring seal 154 is engaged. It is to be noted that the second threaded portion 168 of the second housing portion 140 has a radial diameter that is smaller than the adjacent inner wall of the second housing portion 140. As such, a base of the threaded portion 164 provides a shoulder-like structure against which the O-ring seal 154 is engaged.

When the second housing portion 140 is in the second position (see FIG. 7) relative to the first housing portion 130, via tightening the threaded portion 164 into the second threaded portion 168 of the second housing portion 140, the O-ring seal 154 is seated between the shoulder-like structure provided by the threaded portion 164 and the shoulder-like structure provided by the second threaded portion 168. As such the O-ring seal 154 seals between the first and second housing portions 130, 140.

It is to be noted that, due to the outward telescoping of the second housing portion 140 relative to the first housing portion 130, an additional portion 132A of the hollow interior 132 is made available. See FIG. 5 within which the additional portion 32A that is within the second housing portion 140 is visible (albeit due to the view being exploded). See that via a comparison of FIG. 7 to FIG. 6, the additional portion 132A of the hollow interior 132 is present within the example closure 110. The additional portion 132A of the hollow interior 132 is hidden from view within FIG. 7 and thus is designated via use of a hidden-indicating lead line for the reference numeral 132A within FIG. 7. As such, closure 110 is an example of a closure wherein the second housing portion 140 remains (i.e., is not removed) with the first housing portion 130 for a relatively smaller hollow interior (i.e., only 132) of the closure and a relatively larger hollow interior (i.e., 132 and 132a) of the closure.

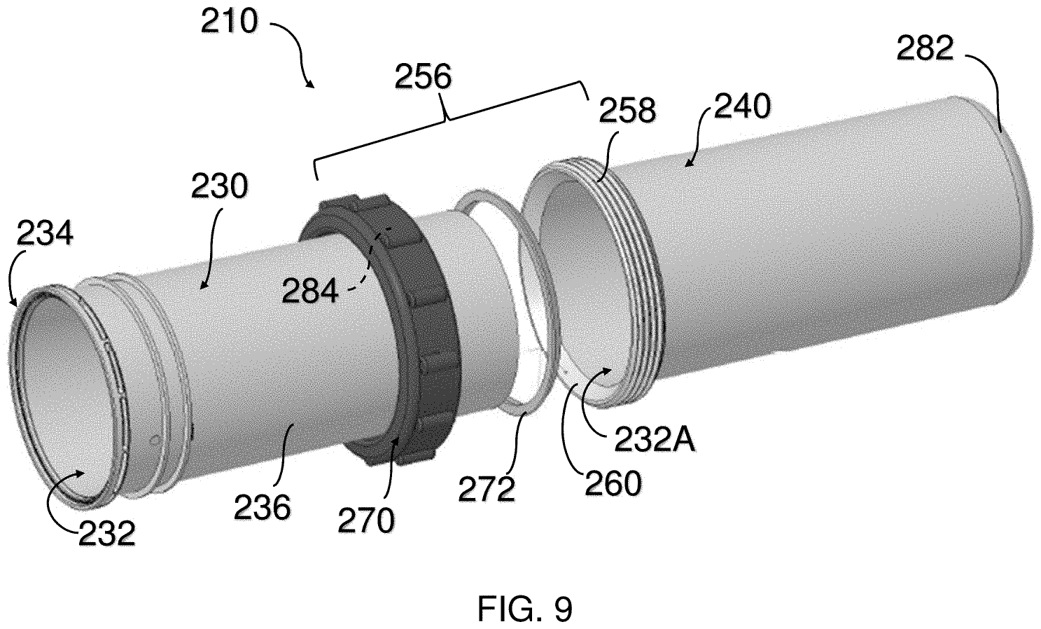

FIGS. 9-11 show an example closure 210 in accordance with at least one aspect of the present disclosure. The example closure 210 includes an ability to telescope to change volume size of a hollow interior 232 of the closure 210.

The example closure 210 includes a first housing portion 230 enclosing at least a portion of the hollow interior 232 of the closure 210. Within the shown example, the first housing portion 230 has a cylindrical shape. Within an example, at least one line splice holder, possibly the example line splice holder 22 (FIG. 4), is to be located within the hollow interior 232. The first housing portion 230 has a portal 234. Within the shown example, the portal 234 is an open end (e.g., an opening) at an axial end of the cylindrical shape. Within an example, plural lines, such as the lines 20 shown within FIG. 4, extend into the hollow interior 232 through the portal 234. It is to be appreciated that the portal 234 may receive structure (e.g., a cap, a plug or similar, such as shown as part of the other structure(s) 24 shown within FIG. 4.

The example closure 210 includes a second housing portion 240. It is to be appreciated that the second housing portion 240 is actuatable with respect to the first housing portion 230 to provide an additional portion 232A of the hollow interior 232. Within an example, the additional portion 232A of the hollow interior 232 is a volume to receive one or more additional line splice holder(s).

It is to be appreciated that the aspect of the second housing portion 240 being actuatable with respect to the first housing portion 230 to provide an additional portion 232A of the hollow interior 232 is to be broadly interpreted. In general, the second housing portion 240 is involved in some activity (e.g., motion, attachment, or the like) relative to the first housing portion 230 such that the result is the provision of the additional portion 232A of the hollow interior 232. The present example closure 210 (FIGS. 9-11) is provided as just an example of the aspect of a second housing portion being actuatable with respect to a first housing portion to provide an additional portion of a hollow interior. Other example closures discussed herein provide other examples of the aspect of a second housing portion being actuatable with respect to a first housing portion to provide an additional portion of a hollow interior. However, it is to be appreciated that such discussed examples need not be limitations upon the present disclosure and that other examples are contemplated and within the scope of the present disclosure.

The example closure 210 includes a coupling for connecting the second housing portion 240 to the first housing portion 230, with the coupling connecting the second housing portion 240 to the first housing portion 230 in several selectable positions. It is to be appreciated that the variation among the selectable positions correlates to a variation of size of the additional portion 232A of the hollow interior 232 that is provided by the second housing portion 240.

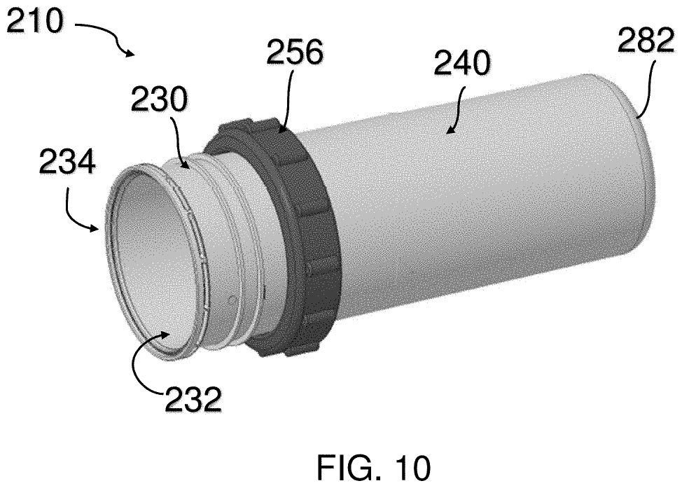

FIG. 10 shows the second housing portion 240 connected to the first housing portion 230 in a first, closed, telescoped-in position. The first position generally is associated with the hollow interior 232 being at a smallest selectable volume. Such is associated with minimal volume size of the additional portion 232A of the hollow interior 232 being provided by the second housing portion 240.

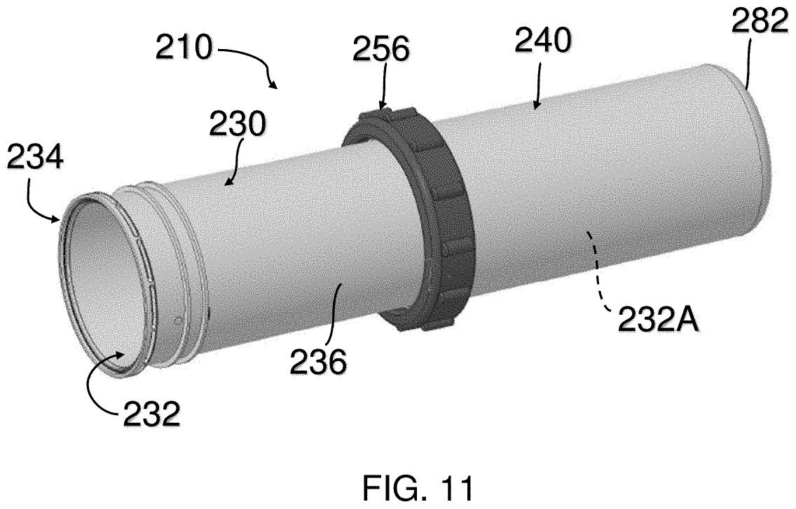

FIG. 11 shows the second housing portion 240 connected to the first housing portion 230 in a second, open, telescoped-out position. The position of FIG. 11 is telescoped outward relative to the position of FIG. 10. The second position generally is associated with the hollow interior 232 being at a largest selectable volume. Such is associated with maximum volume size of the additional portion 232A of the hollow interior 232 being provided by the second housing portion 240.

Within the shown example of FIGS. 9-11, the coupling for connecting the second housing portion 240 to the first housing portion 230 includes a slip-joint compression fitting 256. The fitting 256 includes a segment of the second housing portion 240 that has a male threaded portion 258 (FIG. 9), and within the male threaded portion 258 is a concave annular face 260.

The fitting 256 also includes a collar 270 and an O-ring annular seal 272. Both of the collar 270 and an O-ring annular seal 272 are sized to circumscribe a smooth cylindrical outer surface 236 of the first housing portion 230. The O-ring annular seal 272 fits around the cylindrical surface 236 of the first housing portion 230 with a relatively tight fit. Moreover, the O-ring annular seal 272 may have a cross-sectional profile that has a portion that generally mates to the concave annular face 260 on the second housing portion 240.

The collar 270 has a partial hollowness that envelopes the O-ring annular seal 272. Also, the collar 270 has a female threaded portion 284 (shown via a hidden-indicating lead line for the reference numeral) within such partial hollowness of the collar 270. The female threaded portion 284 mates within the male threaded portion 258 on the second housing portion 240. When the female threaded portion 284 is tightened onto the male threaded portion 258, the O-ring annular seal 272 is compressed against the concave annular face 260 on the second housing portion 240. Such compression also causes the O-ring annular seal 272 to press against the cylindrical surface 236 of the first housing portion 230. Thus, the O-ring annular seal 272 seals between the first and second housing portions 230, 240 and helps to hold the first and second housing portions 230, 240 relative to each other.

Loosening of the collar 270 (i.e., loosening of the female threaded portion 284 relative to the male threaded portion 258), allows the O-ring annular seal 272 to relax and reduces the compression of the O-ring annular seal 272 against the concave annular face 260 and the cylindrical surface 236 of the first housing portion 230. Within the compression reduced, the second housing portion 140, and the collar 270 and O-ring annular seal 272, may be moved (i.e., slid) relative to the first housing portion 230. The first and second housing portions 230, 240 may relatively slide, in a telescope manner, to any of the selectable positions, including the first position (FIG. 10) and the second position (FIG. 11). As such, closure 210 is an example of a closure wherein the second housing portion 240 remains (i.e., is not removed) with the first housing portion 230 for a relatively smaller hollow interior (i.e., only 232) of the closure and a relatively larger hollow interior (i.e., 232 and 232a) of the closure. Again, it is to be appreciated that the use of threaded portions provides just an example and that other examples, which include other constructions and configurations (e.g., other/additional portions) for connection of the housing portions, are within the scope of the present disclosure. For example, collars, clamps, twist-locks, interfitting portions, etc. to hold the housing portions may be included within other examples that are within the scope of the present disclosure.

It is to be appreciated that the above discussed broad example is to provide a broad appreciation of the scope of the disclosure. It is to be appreciated that additional/different components/structures/features may be provided.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first location and a second location correspond to location A and location B or two different or two identical locations or the same location.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are to be construed to mean “one or more” unless specified otherwise or clear from context to be directed to a singular form. Also, at least one of A and B or the like means A or B or both A and B. Furthermore, to the extent that “includes”, “having”, “has”, “with”, or variants thereof are used in either the detailed description or the claims, such terms are intended to be inclusive in a manner similar to “comprising.”

Also, although the disclosure has been illustrated and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A closure enclosing and protecting at least one line splice holder, the closure comprising:
a first housing portion enclosing at least a portion of a hollow interior of the closure, the at least one line splice holder being located within the hollow interior, the first housing portion having a portal through which plural lines extend into the hollow interior;
a second housing portion actuatable with respect to the first housing portion to provide an additional portion of the hollow interior, the additional portion of the hollow interior being a volume to receive additional of the at least one line splice holder; and
a coupling for connecting the second housing portion to the first housing portion.

2. The closure as set forth in claim 1, wherein the coupling includes a threaded portion on the first housing portion, the closure includes a removable cap to be threaded onto the threaded portion on the first housing portion, and the coupling including a threaded portion on the second housing portion to mate with the threaded portion on the first housing portion when the cap is removed and replaced with the second housing portion during actuation of the second housing portion.

3. The closure as set forth in claim 1, wherein the second housing portion includes another threaded portion to permit the cap to be threaded thereon.

4. The closure as set forth in claim 1, wherein the first housing portion and the second housing portion telescope relative to each other during actuation of the second housing portion.

5. The closure as set forth in claim 4, wherein the coupling includes one threaded portion on one of the first and second housing portions and the coupling includes two, spaced apart, threaded portions on the other of the first and second housing portions, the one threaded portion on the one of the first and second housing portions threadingly mates with a first of the two threaded portions on the other of the first and second housing portions when the second housing portion is at a first telescope position relative to the first housing portion, and the one threaded portion on the one of the first and second housing portions threadingly mates with a second of the two threaded portions on the other of the first and second housing portions when the second housing portion is at a second telescope position relative to the first housing portion.

6. The closure as set forth in claim 4, wherein the coupling includes an adjustable friction fitting that provides a movement-resistive friction between the first and second housing portions, the friction fitting being adjusted to reduce friction to permit relative movement of the first and second housing portions between first and second relative telescope positions and the friction fitting being adjusted to increase friction to resist relative movement of the first and second housing portions at the first and second relative telescope positions.

7. The closure as set forth in claim 1, wherein the second housing portion is removed from the first housing portion to provide a relatively smaller hollow interior of the closure and the second housing portion is added to the first housing portion for a relatively larger hollow interior of the closure.

8. The closure as set forth in claim 1, wherein the second housing portion remains with the first housing portion for a relatively smaller hollow interior of the closure and a relatively larger hollow interior of the closure.

9. The closure as set forth in claim 8, wherein the second housing portion includes multiple threaded portions that are selectively engaged with a threaded portion on the first housing portion.

10. The closure as set forth in claim 1, wherein a collar is provided on the first housing portion, and the collar provides for compression to hold the second housing portion relative to the first housing portion.

11. A closure enclosing and protecting one or more line splice holders, the closure comprising:
a first housing portion defining a first portion of an interior of the closure;
a second housing portion defining a second portion of the interior of the closure; and
a coupling for connecting the second housing portion to the first housing portion, wherein:
the first housing portion and the second housing portion are movable relative to one another between a first position and a second position;
when the first housing portion and the second housing portion are in the first position relative to one another, the interior of the closure has a first volume;
when the first housing portion and the second housing portion are in the second position relative to one another, the interior of the closure has a second volume greater than the first volume;
the first volume accommodates a first number of the one or more line splice holders; and
the second volume accommodates a second number, greater than the first number, of the one or more line splice holders.

12. The closure as set forth in claim 11, wherein the first housing portion defines a first portal through which one or more lines pass into the interior of the closure for association with at least some of the one or more line splice holders.

13. The closure as set forth in claim 11, wherein the coupling comprises:
a first mating portion on the first housing portion;
a second threaded portion on the second housing portion to mate with the first mating portion on the first housing portion when the first housing portion and the second housing portion are in the second position relative to one another; and
a third mating portion on a cap of the closure to mate with the first mating portion on the first housing portion when the first housing portion and the second housing portion are in the first position relative to one another.

14. The closure as set forth in claim 13, wherein the first mating portion is a first threaded portion.

15. The closure as set forth in claim 14, wherein the second mating portion is a second threaded portion.

16. The closure as set forth in claim 15, wherein the third mating portion is a third threaded portion.

17. The closure as set forth in claim 11, wherein the first housing portion and the second housing portion telescope relative to one another between the first position and the second position.

18. The closure as set forth in claim 17, wherein the coupling includes one mating portion on one of the first and second housing portions and the coupling includes two, spaced apart, mating portions on the other of the first and second housing portions, the one mating portion on the one of the first and second housing portions mates with a first of the two mating portions on the other of the first and second housing portions when the second housing portion is at a first telescope position relative to the first housing portion, and the one mating portion on the one of the first and second housing portions mates with a second of the two mating portions on the other of the first and second housing portions when the second housing portion is at a second telescope position relative to the first housing portion.

19. The closure as set forth in claim 17, wherein the coupling includes an adjustable friction fitting that provides a movement-resistive friction between the first and second housing portions, the friction fitting being adjusted to reduce friction to permit relative movement of the first and second housing portions between first and second relative telescope positions and the friction fitting being adjusted to increase friction to resist relative movement of the first and second housing portions between the first and second relative telescope positions.

20. A closure enclosing and protecting one or more line splice holders, the closure comprising:
a first housing portion defining a first portion of an interior of the closure, wherein the first housing portion comprises:
a first piece and a second piece;
the first piece and the second piece are connected to one another; and
at least some of the first piece concentrically surrounds at least some of the second piece;
a second housing portion defining a second portion of the interior of the closure; and
a coupling for connecting the second housing portion to the first housing portion, wherein:
the first housing portion and the second housing portion are movable relative to one another between a first position and a second position;
when the first housing portion and the second housing portion are in the first position relative to one another, the interior of the closure has a first volume;
when the first housing portion and the second housing portion are in the second position relative to one another, the interior of the closure has a second volume greater than the first volume;
the first volume accommodates a first number of the one or more line splice holders; and
the second volume accommodates a second number, greater than the first number, of the one or more line splice holders.
